(19) United States
(12) Patent Application Publication
(10) Pub. No.: US 2006/0059169 A1
(43) Pub. Date: Mar. 16, 2006

(54) Method and system for extensible automated data testing using scriptlets

(76) Inventor: Sergey Armishev, San Jose, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 10/917,770

(22) Filed: Aug. 13, 2004

(51) Int. Cl. G06F 7/00

(52) U.S. Cl. 707/100

(57) ABSTRACT

Scriptlets based extensible automated testing software allows for an extendible, scalable and simplified process of testing data messages against standards defined in some data definition language like SECS, XML, ASN1. Scriptlets written in some scripting language like Perl, TCL/TK, BeanShell, JPyton are embedded into such data definitions allowing for a way to formally express requirements of the data items associated with such scriptlets. A data definition compiler compiles such data definitions and creates a database of data messages annotated with scriptlets. When new data message is received the test software identifies which template this message corresponds to and then executes scriptlets associated with this template using the data message and/or previous messages as a context for the scriptlets.

### BACKGROUND OF THE INVENTION

There are many formal data definition languages that allow for formal definition of schema or templates for data messages in a specific domain. Examples of such formal data definition languages are the following (but not limited to): xml schema (see http://www.w3.org/TR/xmlschema-0/#typeContent) which define the structure of xml document and impose restrictions on data values, ASN.1 (see http://www.asn1.org/) notation used to describe data messages in SNMP (simple network messaging protocol) and SECS protocols, TL-1 protocol (see http://www.tl1.com ) used to describe data messages in telecommunications transactions, SECS/GEM data definition and protocol. All these languages usually allow for definitions for only basic requirements specific to the data domain. All other requirements that the language can't handle are usually written in non-formal documentation or comments. Such additional requirements may include, but are not limited to, relationships between values in the current and previous data/documents or relationships between different data fields. For example, how to express a restriction that a particular data field must be incremented exactly by 1 in every next data message? For example, let's say we have an element named “page” in our xml schema. Additionally, we have a document consisting of number of xml documents and each of them has a page attribute. We want to validate that the page order is correct, i.e. the pages start from 1 and increments by one in any subsequent xml document. Using xml schema language we can formally define the page definition as a simple integer type:
<xs:simpleType name=“page”>
   <xs:restriction base=“xs:positiveInteger”/>
</xs:simpleType>
   The only rule that we are able to express here is to use a restriction element which allows us to define a positive integer. In the annotation we can put any additional requirements/restrictions that cannot be expressed in the xml schema language, but gives the verification software developer additional information about what checks need to be done. There is no way in the xml schema to define that every next document must have a page value increased by one and the first one starts from 1. If we can't express this requirement formally then we can't create generic XML processors (name of the software validating XML document) capable of validating compliance of an xml document according to the requirements expressed by the xml schema. Another example is illustrated using an SECS-1 or SECS-II message S6F1. One of the fields in this message requires to be incremented a fixed value in every subsequent message. That requirement is expressed not in a formal language, but rather as plain text in the document defining specific standard. Thus, there exists a need to be able to extend/create any formal data specification language (or data schema language or data template language) in some generic well defined way that on one hand preserves capabilities to express requirements specific to a particular data domain, and on the other hand allows one to formally define requirements that the original schema language was not designed for. Furthermore, there exists a need for a method and system that allows for validation of such additional requirements.

### SUMMARY OF THE INVENTION

The present invention solves the above described need. According to principles of the present invention, a method and system for extensible automated data validation is provided. The method includes creating a data language message definition file where the created file includes a plurality of message definitions which include message structures, data types and associated scriptlets for each message, storing the created file in a central repository, initializing a validation processor which receives a data message to be validated, associating the received data message with a message structure and executing the associated scriptlets on the received message to determine whether the received message is valid or invalid. The scriptlets associated with the message definitions can be annotated as comments when the data language message definition file is created. The method according to principles of the present invention can be applicable to different data definition languages such as XML, SECS/GEM, and ASN.1

In an alternative embodiment, a method according to principles of the present invention includes creating a data definition language message definition file including scriptlets for evaluating data, compiling the data definition language message definition file to create a data definition language message definition database including data definition language message structures, data types and scriptlets, initializing testing of a software module, receiving a message from the software module, determining that the message needs to be tested and testing the received message with a scriptlet interpreter. The scriptlet interpreter searches the database for the message definition corresponding to the received message and then executes the scriptlets associated with the message definition. In one embodiment, if a corresponding message definition is not found for the received message, the received message is considered valid. Alternatively, if there is no corresponding message definition in the message database, the received message can be considered invalid.

A system for implementing the hereinbefore described method includes a compiler for creating and compiling the message definition database, a central repository for storing the database, a validation processor for receiving a data message and running a validation protocol, and a scriptlet interpreter for executing the scriptlets on the received messages to determine if the messages are valid or invalid.

### BRIEF DESCRIPTION OF THE DRAWINGS

Other features and advantages of the invention, both as to its structure and its operation, will best be understood and appreciated by those of ordinary skill in the art upon consideration of the following detailed description and accompanying drawings, in which:

FIG. 1 is a simplified block diagram showing components of a system according to principles of the present invention;

FIG. 2 is a simplified flow chart showing a first embodiment of a method according to principles of the present invention;

FIG. 3 is a simplified flow chart showing an alternative embodiment of a method according to principles of the present invention; and

FIGS. 4A and 4B show examples of message definition files according to principles of the present invention.

### DETAILED DESCRIPTION

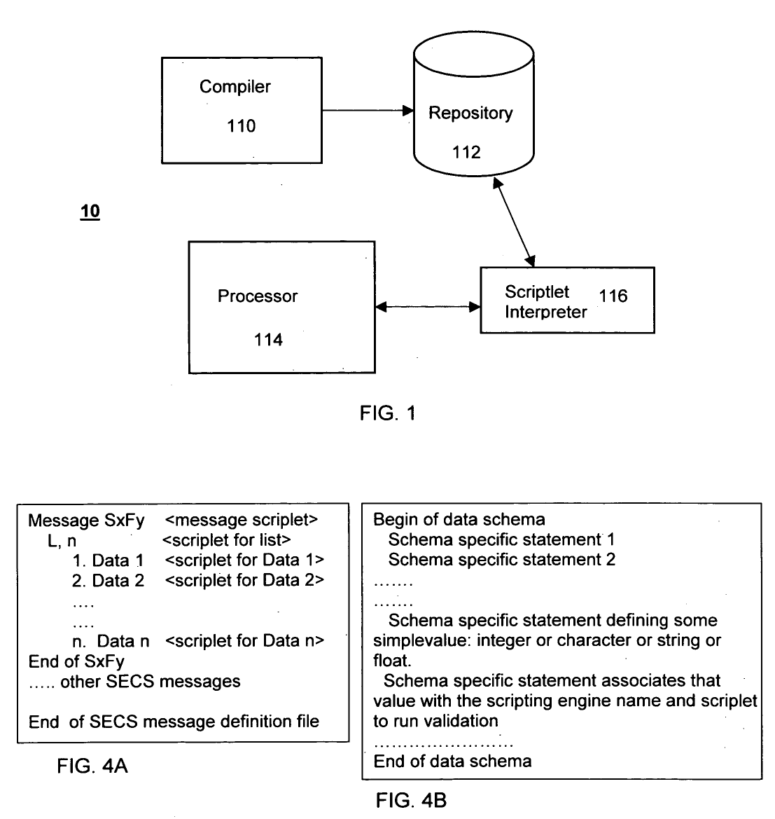

Referring to FIG. 1, the basic elements comprising a preferred embodiment of a system 10 in accordance with principles of the present invention are shown. A compiler 110 is used to define and compile a database of data language message definitions having annotated scriptlets, which is stored in the repository 112. A processor, 114 receives a message or data to be validated and executes a validation protocol which causes a scriptlet interpreter 116 to execute scriptlets on the received message for validating the received message against the message definitions stored in the repository 112.

The present invention provides a solution, to the hereinbefore described problem, using small script, or scriptlets embedded in the validation protocol. The term scriptlets as defined in http://java.sun.com/products/jsp/whitepaper.html, Section “Scripting Elements,” refers to a code fragment, executed at request time processing. In this Java usage, scriptlets may be combined with static elements on the [HTML] page to create a dynamically generated [HTML] page. However, in the present invention, we use scriptlets for dynamically identifying and verifying data element inside, for instance in one embodiment, an SECS message they are associated with. Generally, the present invention consists of 1) a data schema, or scripting, language and script interpreter, 2) scriptlets, 3) a formal message definition language which includes scriptlets and 4) a software test, or validation, engine. The scriptlets are made up of correct expressions of the scripting language, tags and attributes defining the context in which scripting expressions are to be evaluated, and default scriptlets. For example we can define a default scriplet such that the received data type should be the same type as in a message definition. And then apply this default scriplet to all data items where scriptlets are not specifically written. The software test, or validation, engine includes an interpreter for specific data messages which interprets data schemas/templates/message definitions, identifies message data structures, identifies scriptlets and associates them with corresponding data elements. The validation engine also includes a central storage or database for storing the data schemas/message definitions and scriptlets. Lastly, the validation engine includes an extendable scripting or test engine which performs test procedures by executing scriptlets using current and previous messages in the scriplet context. The scripting engine can operate in BeanShell, JavaScript, Tcl/Tk, Perl or other similar scripting languages.

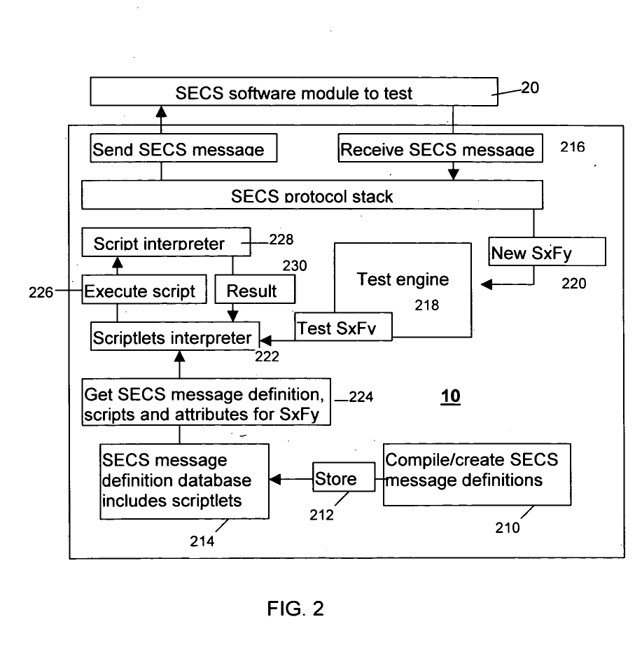

Turning now to FIGS. 2 and 4A, the above described components are employed to perform an embodiment of the inventive method as follows. In this embodiment, the inventive method uses scriptlets to provide dynamic identification and verification for data elements inside an SECS message they're associated with. First, an SECS message definition file is created and every field that needs to be specifically tested with scriptlets is annotated. For existing message definition files developed for other SECS testing tools scriptlets might be written as comments to corresponding data items. This way all previously defined files could continue to be used as before and as taught by the present invention. If a field allows for using some default scriptlets, leave that associated scriplet field empty. An example of an SECS message definition file is shown in FIG. 4A.

Referring to FIG. 2, the message definition file is compiled 210 to create SECS message definition database which includes SECS message structure, data types and scriptlets. The database is stored 212 in a central repository 214. Next, the system 10 is in communication with the software module under test 20. When an SECS message is received 216, the test engine 218 identifies that this is a new message 220 that needs to be tested and calls scriptlets interpreter 222 to test the received new message 220. The scriptlets interpreter searches the SECS message definition database 214 and gets an SECS message definition 224 corresponding to received SECS message 220. If a definition is not found then a valid message is assumed. Alternatively, if a definition is found, scriplet interpreter 222 parses the received SECS message and executes 226 corresponding scripts (including default ones) in a script interpreter 228. If any of the scripts fail, scriptlet interpreter passes the result 230 back to the scriptlet interpreter 222 and informs the test engine 218 that the message check failed. If the goal isn't to check but to identify a particular message then a failure indicates that a given message hasn't satisfied a particular criteria. Successful scriptlets execution indicates that the message satisfies the particular criteria. Then the message could be recorded for example in a log file.

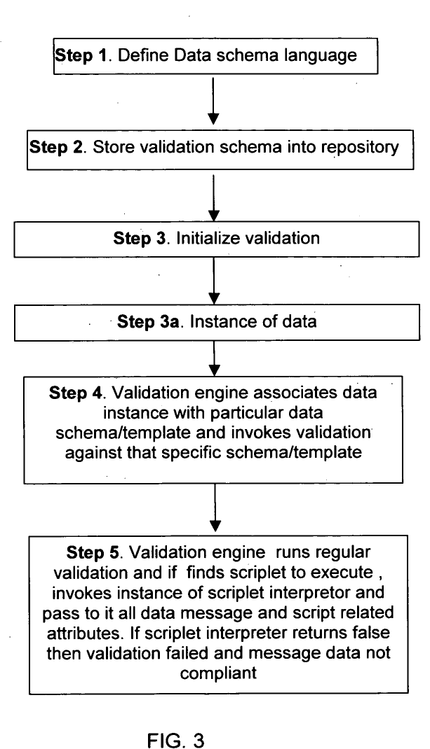

FIG. 3 shows an alternative embodiment of the invention. In Step 1, one or more data schemas or templates, using a data schema language with a scriptlets mechanism, is created. Next, Step 2 sets forth that the created data schema is stored in a central repository or database. At this point, the validation process can be started as depicted by Step 3. Generally, this involves initializing a validation processor and validation, or verification, protocol which allows for receiving specific data messages, Step 3a. Next, in Step 4, when a next data message is received, the schema validation processor defines which schema/s is/are applicable to that particular message. In the case of xml document, the xml document itself references the validation schema. In the case of SECS messages or other network protocol related messages where usually the reference to the data schema isn't defined clearly in the message itself, the association between the data message and validation schema is calculated based on some rules particular to those specific messages. In the case of SECS messages such association might be based upon:
stream and function numbers. For example, somebody might request that all S6,F1 messages must conform to some validation schema (or template) named S6F1_TEMPLATE;
stream, function and value/values of specific fields in the message. For example; somebody might request that the particular validation schema/template be applicable only to S6,F1 messages which have TRID value equals 1 (see example of S6,F1 message below); or
stream, function and scriptlets associated with particular fields. For example, somebody might request that the particular validation schema/template be applicable only to S6,F1 messages which have TRID value in between 1 and 100.
   If no data schemas/templates are found, the data message is assumed to be valid.

Lastly, in Step 5, the validation processor runs the validation process validating the data message against particular data schema until it finds that a particular data field requires scriptlet execution for validation. If any of the scripts fail, scriptlet interpreter informs the validation processor that the message check failed. Similar to the first embodiment described above, if the goal isn't to check but to identify a particular message, then a failed scriplet indicates that given message hasn't satisfied a particular criteria. Successful scriptlets execution indicates that the message satisfies our criteria. Then such message might be recorded.

In operation, the above described features of the present invention can be implemented in the following examples. The first example is for testing an SECS message, while the second example is directed at a solution for XML page schema attributes. Here in the first example, principles of the present invention are applied to verify SECS message correctness. In this particular example we use an S6F1 messages. As it is defined in standard “SEMI E5-0304. SEMI EQUIPMENT COMMUNICATION STANDARD 2 MESSAGE CONTENT (SECS-II),” incorporated herein by reference, on p. 118 the message structure must be the following:

L, 4
1. <TRID>
2. <SMPLN>
3. <STIME>
4. L, n
   1. <SV1>
   2. <SV2>
   . . .
   n. <SVn>
      where:

L is the SECS list

TRID (see same document p. 38) is a trace id

SMPLN (see same document p. 34) is a sample number

STIME (see same document on p. 36) is a sample time

SV (see same document on p. 36) is a status variable value

Those S6F1 messages tool sends in response to S2F23 message which setup data collection parameters: TRID, SV1, SV2, . . . SVN

Let's consider example on p. 85 from the document “SEMI E30-1103. GENERIC MODEL FOR COMMUNICATION AND CONTROL OF MANUFACTURING EQUIPMENT (GEM)”

S2,F23 sent by host:

| TRID = ABCD | | | | | |
|---|---|---|---|---|---|
| DSPER = 000100 (One minute per period) | | | | | |
| TOTSMP = 9 | | | | | |
| REPGSZ = 3 | | | | | |
| SVID1 = Temperature | | | | | |
| SVID2 = Relative humidity | | | | | |
| And S6,F1 looks like this (starting at time 1 a.m.) | | | | | |
| 1 st transmission <L, 4> | | | | | |
| 1. ABCD (trace ID) | | | | | |
| 2. 3 (last sample of the transmission) | | | | | |
| 3. 88 | 05 | 01 | 01 | 03 | 00 |
| Year | Month | Day | Hour | Min | Sec |

| 4. <L, n> n = 2 SVID's × REPGSZ of | | | | | |
|---|---|---|---|---|---|
| 3 = 2 × 3 = 6 | | | | | |
| 72 (temperature) | | | | | |
| 0.29 (relative humidity) | | | | | |
| 73 (temp) | | | | | |
| 0.30 (r.h) | | | | | |
| 71 (temp) | | | | | |
| 0.30 (r.h) | | | | | |
| 2 nd transmission <L, 4> | | | | | |
| 1. ABCD | | | | | |
| 2. 6 | | | | | |
| 3. 88 | 05 | 01 | 01 | 06 | 00 |
| | | | | hr | min |
| 4. <L, 6> | | | | | |
| 73 | | | | | |
| 0.31 | | | | | |
| 71 | | | | | |
| 0.32 | | | | | |
| 71 | | | | | |
| 0.31 | | | | | |
| 3 rd and last transmission <L, 4> | | | | | |
| 1. ABCD | | | | | |
| 2. 9 | | | | | |
| 3. 88 | 05 | 01 | 01 | 09 | 00 |
| | | | hr | min | |

```
      4. <L, 6>
        71
        0.30
        72
        0.30
        71
        0.31
```

Let's say that every time SECS host receives S6,F1 message which has ABCD as a TRID we want to test the following:
1. SMPLN field must start from 3 and increases by 3 in every next message
2. STIME field must start from string 880501
3. List of values must consists of 6 values
4. Temperature value must be in the range of 68 to 78
5. Humidity value must be in the range of 0.28 to 0.33
6. We must receive exactly 3 messages in 7 minutes from the moment we sent S2,F23 message

First step to implement that scenario is to create formal message definition for S2,F23 and S6,F1 message. Let's use SML ® semantics (registered trade mark of GW Associates) as a most commonly use semantics. It is not the only semantics and we can use XML based semantics too for the same purposes.

In SML semantics our messages looks like:

```
For S2,F23 message
SEMATECH_TRACE: S2F23 W
<L[4]
  <A ‘ABCD’>  * TRID
  <A ‘000100’>  * DSPER
  <U4 9>  * TOTSMP
  <U4 3>  * REPGSZ
  <L[2]
    <U4 1>  *  SVID1 = Temperature
    <U4 2>  *  SVID2 = Relative humidity
  >
>.
For S6,F1 message template
SEMATECH_S6F1: S6F1 W
<L[4]
  <A ‘ABCD’>  * TRID field must be the same as in S2F23 field
  <U4 3>  * sample number which must be incremented in
each next message
  <A ‘880501010900’> * timestamp in a special format
  <L[6]
    <F8 71>  * data value corresponding to SVID1
    <F8 0.30>  * data value corresponding to SVID2
    <F8 72>  * data value corresponding to SVID1
    <F8 0.30>  * data value corresponding to SVID2
    <F8 71>  * data value corresponding to SVID1
    <F8 0.31>  * data value corresponding to SVID2
  >
>.
And let's put those 2 messages into file SEMATECH.smf
```

In SML® notation everything that goes after * sign assumed to be a comment and ignored. SEMATECH_TRACE and SEMATECH_S6F1 are the arbitrary names. Now we need to create main script and put scriptlets into SEMATECH_S6F1 template message.

Main script function:
1. Create formal template based on SEMATECH_S6F1 and activate it. Here activate means that test engine will be testing every incoming message to define that it should be validated by our schema. See Step 4 of FIG. 3 and the description above.
2. Create counter for those incoming S6F1 messages which passed validation and check that counter not to exceed 3
3. Set script execution time to 8 minutes. This is two minutes more then required for receiving all S6F1 messages and we set it up this way to verify that no more messages coming.
4. Send S2,F23 message which trigger tool to send back S6,F1 messages which we need to verify for compliance

Scriptlet's functions:
1. verify that SMPLN field must start from 3 and increases by 3 in every next message
2. verify that STIME field must start from string 880501
3. verify that list of values must consists of 6 values
4. verify that temperature value must be in the range of 68 to 78
5. verify that humidity value must be in the range of 0.28 to 0.33

The implementation greatly depends on the chosen programming language. Here we assume that we are using BeanShell scripting language which is easily embeddable into Java based software. BeanShell language in this combination has unique capabilities of combining all Java language plus user defined commands and variables. We assume that our version of BeanShell language customized to include 2 variables: cur and prev and one command isFirst( ) which returns true if this is the very first message to validate by given data schema/template. cur and prev value type depends on variable type: for numerical types it's double and for strings or binary arrays it's a string type. Because standard SML® language doesn't include validation scriptlets and tags we extend it and include this information into comments fields (everything that goes after * or // sign). Then

```
SEMATECH_S6F1_1: S6F1 W
<L[4]
  <A ‘ABCD’>
  <U4 3>  * {check= if(isFirst( )) return cur == 3; else return
cur == prev + 3 }
  <A ‘880501010900’>  * {check= cur.startsWith(“880501”);}
  <L[6]
```

| | |
|---|---|
| <F8 71> | * {check = (cur > 68) && (cur < 78);} |
| <F8 0.30> | * {check = (cur > 0.28) && (cur < 0.33);} |
| <F8 72> | * {check = (cur > 68) && (cur < 78);} |
| <F8 0.30> | * {check = (cur > 0.28) && (cur < 0.33);} |
| <F8 71> | * {check = (cur > 68) && (cur < 78);} |
| <F8 0.31> | * {check = (cur > 0.28) && (cur < 0.33);} |
| > | |
| >. | |

Validation processor doing the following:

1. Initializes template SEMATECH_S6F1_{—}1

2. Receive next SECS message

3. Identify that this message should use SEMATECH_S6F1_{—}1 template for validation. The criteria for identifying message template might be different (see Step 4 of FIG. 3 and explanations). For S6F1 messages the most natural (but not the only one) way to identify schema/template to apply based on the TRID field value. There may be more schemas/templates registered so that validation might go through multiple validations.

4.Validation processor compares structure of received S6F1 message with the structure of SEMATECH_S6F1_{—}1 like following:
1. If message is first initialize isFirst( ) method to true, otherwise set it to false
2. Process first list (L[4] field): message and template has list of 4 values
3. Process first item in the list: message and template has first item. If it's the very first message set: value cur=<value of first item>, value prev=cur. Otherwise set: prev=cur and cur=<value of first item>. Check scriptlets: no scriptlets
4. Process second item in the list: message and template has second item. If it's the very first message set: value cur=<value of second item>, value prev=cur. Otherwise set: prev=cur and cur=<value of second item>. Check scriptlets: scriplet exists. Execute scriplet: if(isFirst( )) return cur==3; else return cur==prev+3. Get result of scriplet execution. If return value false or exception happened then validation failed. Print info about failure
5. Process third item in the list: message and template has third item. If it's the very first message set: value cur=<value of third item>, value prev=cur.

Otherwise set: prev=cur and cur=<value of third item>. Check scriptlets: scriplet exists. Execute scriplet: cur.startsWith(“880501”). Get result of scriplet execution. If return value false or exception happened then validation failed. Print info about failure
6. Process second list (L[6] field): message and template has list of 6 values

For every item i-th in the second list:

Process i-th item in the list: message and template has i-th item. If it's the very first message set: value cur=<value of i-th item>, value prev=cur. Otherwise set: prev=cur and cur=<value of i-th item>. Check scriptlets: if scriplet exists then execute scriplet and get result of scriplet execution. If return value false or exception happened then validation failed. Information about any failure can then be reported, or printed for documentary purposes.

Turning now to the second example, any data definition schema language such as xml schema, ASN.1 notation, SECS/GEM or others can be combined with a formal scripting language in such a way that those parts specific to a data domain are expressed in that specific notation. And, those parts that are not specific to this specific domain or can't be defined using that schema language can be defined by scripts embedded in some well defined way into the document. The following is an example illustrating these objectives. Here, the present invention will be applied to the problem with an xml page attribute described above in the Background section.

```
  <xs:simpleType name =“page”>
    <xs:restriction base=“xs:positiveInteger”>
      <xs:script type = “BeanShell” check=“if(isFirst( )) return cur
==1; else return (cur == prev + 1)”/>
    </xs:restriction>/>
  </xs:simpleType>
```

In that simple example we assume that standard xml schema language has been extended to include a new facet with the name script. The script element has a type which defines which scripting language to use and a check which defines code to execute for verification. The check is executed by some scripting engine defined formally by a type attribute which could be based on any existing scripting language like BeanShell, Perl, Tcl/Tk, Python, JavaScript or some new language. Script execution is invoked by an XML processor which knows nothing about that particular scripting language but is capable of invoking the appropriate scripting engine based on its type and then get back result of this script execution. In our example this return value is true or false. We can also assume that scripting engine (or usually extended scripting language) includes at least 2 variables associated with each script facet: current and previous values (when the first document processed we assume current=previous) for the element they associated with and scripting enging can refer to them as cur and prev. Also scripting engine has at least method isFirst( ) which returns true if this is the very first iteration. We also assume that scripting language has some external control which in turn might be some script that initiates the scripting engine and allows to define the very first document. With this assumtion above code solves the problem with the pages. The meaning of this scriptlet is following: if this is the very first page then page number must be 1. Otherwise page number must be incremented by one.

Suppose though, that someone doesn't want to change the xml schema definition but rather change the executing software to recognize special elements which formally conforms to xml schema? The following provides a solution where one can put the content of the script into documentation element:

```
  <xs:simpleType name=“page”>
    <xs:restriction base=“xs:positiveInteger”>
      <xs:annotation>
        <xs:documentation>
        <l>script type =<quot>BeanShel</quot></l>
        <l> value= <quot>if(isFirst( )) return cur ==1;</quot></l>
        <l> <quote> else return (cur == prev + 1);</quote></l>
        </xs:documentation>
      </xs:annotation>
    </xs:restriction>
</xs:simpleType>
```

Here we assume that extended XML processor is capable to parse a documentation element in such a way that it recognizes the script type and value and then invokes an appropriate scripting engine to execute the scriptlet. The main idea here is to put scriptlets into the field which is usually treated as some kind of comment or, as in the case of xml schema, into the documentation field. ASN.1 as well as SECS/GEM data schemas have such comment field.

As shown from the above embodiments and examples, the present invention provides a number of advantages over the prior art. First, it allows one to define data restrictions that are usually not allowed to be defined using usual schema definition language like xml, ASN.1, SECS/GEM. Second, it allows an end user and/or software supplier (1) to use any scripting language, (2) extend the scripting language independently from the main data schema processor, (3) formally define data schema requirements that had not previously been possible to define, and (4) build new breadth of validation processors with embedded scripting language. Additionally, no prior art software for SECS testing have used scriptlets which allow for associating test scripts with data to be tested all in a single file. More specifically, the present invention's feature of including scriptlets into comment fields of particular message definition files allows for reusing all existing old definitions with the new software.

A further advantage over existing validation software is that the present method of using scriptlets in data definition files allows for creating standard based software validating requirements/restrictions that had not been possible to implements before. This enables the users of such software to include their own requirements/restrictions without changing validation software.

Having thus described various embodiments of the invention, it will now be understood by those skilled in the art that many changes in construction and circuitry and widely differing embodiments and applications of the invention will suggest themselves without departure from the spirit and scope of the invention. The disclosures and the description herein are purely illustrative and are not intended to be in any sense limiting. Rather, the invention is to cover all modifications, equivalents, and alternatives falling within the spirit and scope of the invention as defined by the appended claims.

What is claimed is:

1. A method for extensible automated data validation, the method comprising:
creating a data language message definition database;
storing the data language message definition database into a central repository;
initializing a validation processor;
receiving a data message to be validated;
associating the received data message with a message structure stored in the data language message definition database;
executing a scriptlet on the data message based on the associated message structure; and
providing an indication that the data message is valid if execution of the scriptlet is successful.

2. The method according to claim 1, wherein data language message definition database includes a plurality of message definitions and wherein the step of creating the data language message definition database further comprises annotating fields of the message definitions with scriptlets.

3. The method according to claim 2, wherein the step of creating the data language message definition database comprises:
compiling a data language message definition file; and
creating the data language message definition database including the message structures, data types and the scriptlets.

4. The method according to claim 3 wherein the scriptlets comprise correct expressions of the data language and tags and attributes defining a context in which data messages must be evaluated.

5. The method according to claim 4 wherein the data language is Semi Equipment Communications Standard (SECS).

6. The method according to claim 4 wherein the data language is XML.

7. The method according to claim 4 wherein the data language is ASN.1.

8. A method for extensible automated data testing comprising:
creating a data definition language message definition file including scriptlets for evaluating data;
compiling the data definition language message definition file to create a data definition language message definition database, the database including data definition language message structures, data types and scriptlets;
initializing testing of a software module;
receiving a message from the software module;
determining that the message needs to be tested; and
testing the received message with a scriptlet interpreter.

9. The method according to claim 8, wherein the step of testing the received message comprises:
searching the data definition language message definition database to retrieve the data definition language message definition corresponding to the received message; and
executing scriptlets associated with the retrieved data definition language message definition, wherein successful execution of the scriptlets indicates that the message is valid.

10. The method according to claim 9, wherein if a corresponding data definition language message definition is not found in the message definition database, the received message is assumed to be valid.

11. The method according to claim 9, wherein if a corresponding data definition language message definition is not found in the message definition database, the received message is assumed to be invalid.

12. The method according to claim 9, wherein the data definition language is XML.

13. The method according to claim 9, wherein the data definition language is SECS/GEM.

14. The method according to claim 9, wherein the data definition language is ASN.1.

15. A system for extensible automated validation of data messages comprising:
a data definition compiler for creating and compiling a database of data language message definitions having annotated scriptlets;
a central repository for storing the database;
a validation processor for receiving a data message and implementing a validation protocol; and
a scriptlet interpreter in communication with the validation processor and the central repository for executing scriptlets on the received data message to determine if the data message is valid.
